(19) United States
(12) Patent Application Publication
(10) Pub. No.: US 2015/0192155 A1
(43) Pub. Date: Jul. 9, 2015

(54) Image Capture System and Clamping Mechanism

(71) Applicants: Sintai Optical (Shenzhen) Co., Ltd., Shenzhen (CN); Asia Optical International Ltd., Tortola (GB)

(72) Inventor: Kun-Lun Chen, Taichung (TW)

(21) Appl. No.: 14/589,003

(22) Filed: Jan. 5, 2015

(30) Foreign Application Priority Data
Jan. 6, 2014 (TW) 103100329

(51) Int. Cl. F16B 2/06; G03B 17/56; H04N 5/225

(52) U.S. Cl. CPC F16B 2/06; H04N 5/2251; G03B 17/561

(57) ABSTRACT

A clamping mechanism includes a main body having a first end; a first clamping member rotatably disposed at the first end; a second clamping member corresponding to the first clamping member; and at least one connecting member movable with respect to the main body, wherein the second clamping member is connected to the connecting member.

### BACKGROUND OF THE INVENTION

1. Field of the Invention

The invention relates to an image capture system and a clamping mechanism.

2. Description of the Related Art

Handheld devices have become indispensible in daily life recently.

Referring to FIG. 1, a conventional clamping mechanism 100 includes a first clamping arm 110, a second clamping arm 120 and a shaft 130. The first clamping arm 110 is rotatably connected to the second clamping arm 120 by the shaft 130. When the clamping mechanism 100 is opened, a handheld device (not shown) is held between the first clamping arm 110 and the second clamping arm 120.

The problem of the conventional clamping mechanism 100 is that the first clamping arm 110 and the second clamping arm 120 cannot hold the handheld device tightly. Therefore, when the handheld device is held by the first clamping arm 110 and the second clamping arm 120, a surface or screen of the handheld device is very easily damaged by improper operation. Further, the handheld device may fall out of the clamping mechanism 100 due to an external impact or clamping at an improper angle.

### BRIEF SUMMARY OF THE INVENTION

The invention provides an image capture system and a clamping mechanism. The clamping mechanism is able to hold a mechanical system or an electronic system and contact the mechanical system or the electronic system through a protecting layer to prevent the mechanical system or the electronic system from sliding on the clamping mechanism, whereby the mechanical system or the electronic system is not scratched by the clamping mechanism and even does not fall off the clamping mechanism.

The clamping mechanism in accordance with an exemplary embodiment of the invention includes a main body having a first end; a first clamping member rotatably disposed at the first end; a second clamping member corresponding to the first clamping member; and at least one connecting member movable with respect to the main body, wherein the second clamping member is connected to the connecting member.

The image capture system in accordance with an exemplary embodiment of the invention includes a camera module and a clamping mechanism joined to the camera module. The clamping mechanism includes a main body, a first clamping member rotatably disposed on the main body, a second clamping member corresponding to the first clamping member and at least one connecting member movably connecting the main body and the second clamping member.

The clamping mechanism in accordance with another exemplary embodiment of the invention includes a main body, a first clamping member, a second clamping member, and at least one connecting member. The first clamping member is rotatably connected to the main body. The second clamping member is disposed away from the first clamping member. The connecting member is movable with respect to the main body, wherein the second clamping member is connected to the connecting member.

The image capture system in accordance with another exemplary embodiment of the invention includes a camera module and the above-mentioned clamping mechanism which holds the camera module by the first clamping member and the second clamping member.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of a conventional clamping mechanism;

FIG. 2 is a schematic view of an embodiment of a clamping mechanism of the invention, wherein a first clamping member and a second clamping member of the clamping mechanism are stretched;

FIG. 3 is a schematic view of an embodiment of a clamping mechanism of the invention, wherein a connecting member stretches out of a main body;

FIG. 4 is a schematic view of an embodiment of a clamping mechanism of the invention, wherein a first clamping member and a second clamping member are retracted;

FIG. 5 depicts an embodiment of a clamping mechanism of the invention being used;

FIG. 6 is a schematic view of another embodiment of a clamping mechanism of the invention, wherein a first clamping member and a second clamping member of the clamping mechanism are stretched; and

FIG. 7 is a schematic view of an embodiment of an image capture system of the invention.

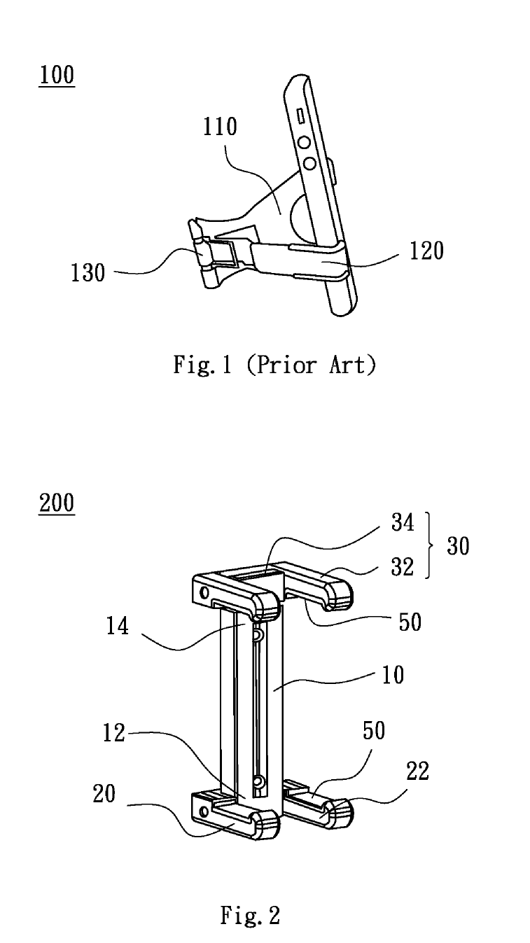

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

An embodiment of a clamping mechanism 200 of the invention includes a main body 10, a first clamping member 20, s second clamping member 30 and at least one connecting member 40.

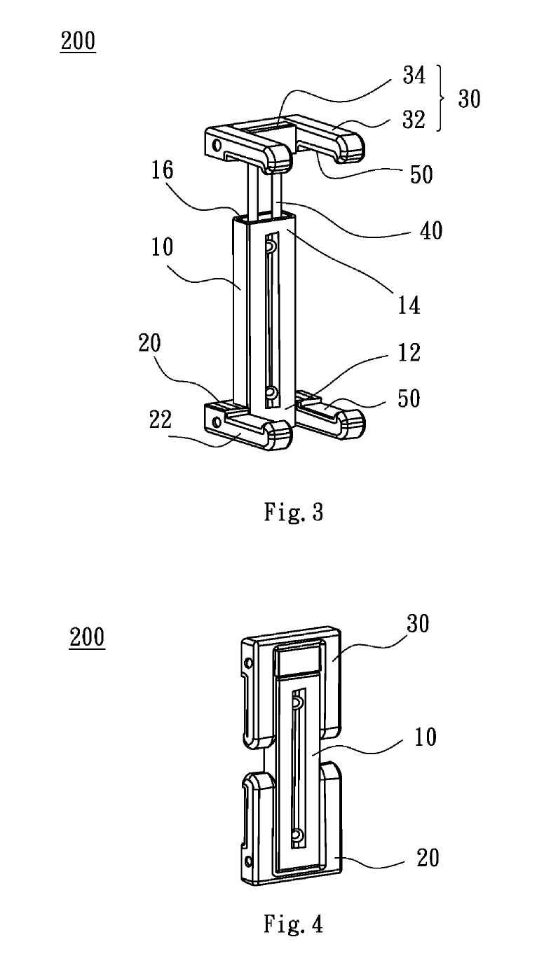

Referring to FIGS. 2 and 3, the main body 10 has a first end 12 and a second end 14. The first end 12 is opposite to the second end 14. The first clamping member 20 is disposed at the first end 12 and rotatable with respect to the main body 10. The second clamping member 30 corresponding to the first clamping member 20 is disposed at the second end 14. The connecting member 40 is movable with respect to the main body 10 and connects the second end 14 of the main body 10 and the second clamping member 30.

As shown in FIG. 3, the main body 10 includes two chambers (not shown). Each of the chambers has an opening 16 formed on the second end 14. The chambers extend from the opening 16 to the first end 12.

The connecting member 40 is disposed and movable in the chambers. In this embodiment, the clamping mechanism 200 includes two connecting member 40. One end of the connecting members 40 is fixed to the second clamping member 30, and the other end of the connecting members 40 is inserted into each of the two chambers respectively. The connecting member 40 may be a metal rod, metal tube, plastic rod or plastic tube.

In another embodiment, when the connecting member 40 is completely received in the chamber, the distance between the first clamping member 20 and the second clamping member 30 is 45 mm. When the first clamping member 20 and the second clamping member 30 are pulled in opposite directions, a part of the connecting member 40 is moved out of the chamber. In another embodiment, the distance between the first clamping member 20 and the second clamping chamber 30 is 70 mm. The invention is not limited thereto.

In yet another embodiment, the second clamping member 30 includes at least one claw portion 32 and a fixing portion 34. The fixing portion 34 is fixed to the connecting member 40, and the claw portion 32 is disposed on the fixing portion 34 and rotatable with respect to the fixing portion 34.

In another embodiment, the clamping mechanism 200 further includes a protective layer 50. As shown in FIG. 2, the protective layer 50 is disposed on a surface of the claw portion 32 of the second clamping member 30 facing the first clamping member 20 and/or disposed on a surface of the claw portion 22 of the first clamping portion 20 facing the second clamping member 20. The claw portions 22 and 32 and the fixing portion 34 are made of hard plastic, and the protective layer 50 is made of soft plastic or rubber.

Referring to FIG. 4, the first clamping member 20 and the second clamping member 30 are retracted.

Compared with FIG. 2 and FIG. 4, when the first clamping member 20 and the second clamping member 30 are stretched, an angle is formed between the first clamping member 20 and the main body 10 and between the second clamping member 30 and the main body 10. The angle ranges between 30° to 120°, but the invention is not limited thereto. When the clamping mechanism 200 is received, the main body 10, the first clamping member 20 and the second clamping member 30 are parallel. At this time, the angle between the first clamping member 20 and the main body 10 is 0, and the angle between the second clamping member 30 and the main body 10 is also 0.

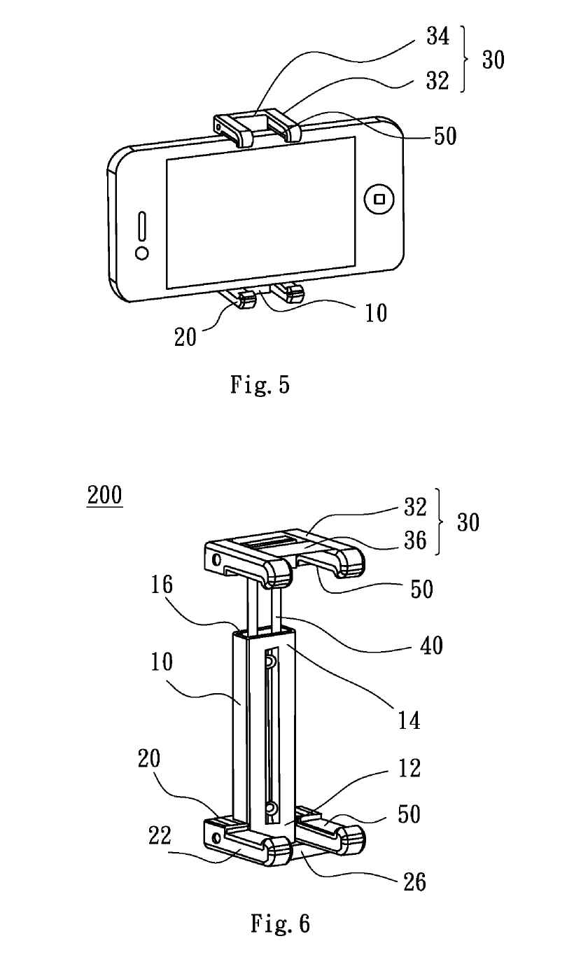

Referring to FIG. 5, the clamping mechanism 200 can be used to hold any mechanical system or electronic system. The mechanical system includes image capture system, communication system or handheld device, but it is not limited thereto.

In an embodiment, the mechanical system or the electronic system is held between the first clamping member 20 and the second clamping member 30. Because various mechanical systems or electronic systems may have different widths, the connecting member 40 can be moved relative to the main body 10 to vary the distance between the first clamping member 20 and the second clamping member 30 so that the clamping mechanism 200 is adapted to various mechanical systems or electronic systems. The distance between the first clamping member 20 and the second clamping member 30 can reach 70 mm in this embodiment, but it is not limited thereto.

In another embodiment, the connection between the first clamping member 10 and the main body 10 is similar to the connection between the second clamping member 30 and the main body 10. The first clamping member 20 is connected to the first end 12 of the main body 10 by another connecting member (not shown) in such a manner that the first clamping member 20 is movable with respect to the main body 10.

In addition, when the clamping mechanism 200 holds a mechanical system or an electronic system, the clamping mechanism 200 contacts the mechanical system or the electronic system through the protecting layer 50. Therefore, the protecting layer 50 protects the mechanical system or the electronic system from being scratched by the claw portions 22 and 32. The protecting layer 50 also prevents the mechanical system or the electronic system from sliding or falling out of the clamping mechanism 200.

Referring to FIG. 6, in yet another embodiment, a thin surface 26 connects two claw portions 22 of the first clamping member 20, and a thin surface 36 connects two claw portions 32 of the second clamping member 30 to increase mechanical strength of the first clamping member 20 and the second clamping member 30.

In another embodiment, a net structure (not shown) is disposed between two claw portions 22 of the first clamping member 20 and between two claw portions 32 of the second clamping member 30 to increase mechanical strength of the first clamping member 20 and the second clamping member 30.

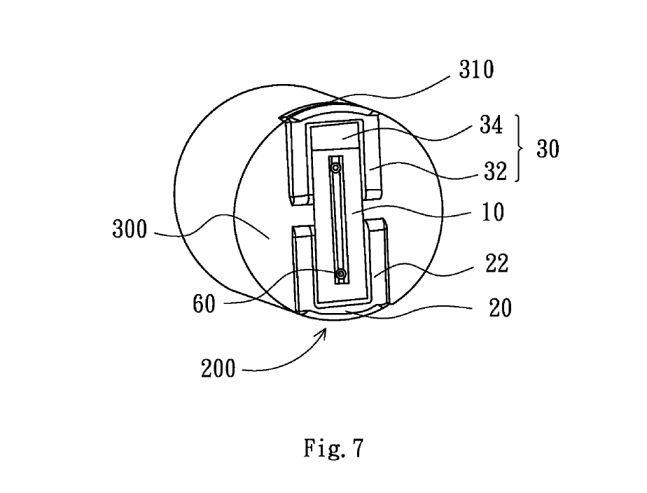

Referring to FIG. 7, an image capture system of the invention includes the clamping mechanism 200 and a camera module 300. The clamping mechanism 200 of this embodiment is similar to the clamping mechanism 200 of FIGS. 2 to 4. The same elements are identified by the same numbers.

The clamping mechanism 200 includes a main body 10, a first clamping member 20, a second clamping member 30 and at least one connecting member 40. The camera module 300 includes a receiving space 310. The clamping mechanism 200 is fixed to the receiving space 310 of the camera module 300.

Referring to FIGS. 4 and 7, the first clamping member 20 is rotatably disposed on the main body 10. The second clamping member 30 corresponding to the first clamping member 20. The connecting member 40 connects the main body 10 and the second clamping member 30 in such a manner that the connecting member 40 is movable with respect to the main body 10.

In an embodiment, the camera module 300 includes a lens and an image sensor, but the invention is not limited thereto.

Furthermore, in another embodiment, the clamping mechanism 200 includes a detachable securing member 60. The detachable securing member 60 secures the main body 10 to a receiving space 310 of the camera module 300, whereby the clamping mechanism 200 is secured to the camera module 300 by the securing member 60. The clamping mechanism 200 can be removed from the camera module 300 according to requirements. The securing member 60 can be a bolt, but the invention is not limited thereto.

What is claimed is:

1. A clamping mechanism, comprising:
a main body comprising a first end;
a first clamping member rotatably disposed at the first end;
a second clamping member corresponding to the first clamping member; and
at least one connecting member movable with respect to the main body, wherein the second clamping member is connected to the connecting member.

2. The clamping mechanism as claimed in claim 1, wherein the main body further comprises a second end, and the connecting member connects the second end and the second clamping member.

3. The clamping mechanism as claimed in claim 2, wherein the main body further comprises at least one chamber having an opening formed at the second end, and the chamber extends towards the first end and receives the connecting member.

4. The clamping mechanism as claimed in claim 1, wherein the first clamping member and/or the second clamping member comprise at least one claw member.

5. The clamping mechanism as claimed in claim 4, wherein the second clamping member further comprises a fixing portion fixed to the connecting member, and the claw portion is rotatably disposed on the fixing portion.

6. The clamping mechanism as claimed in claim 4 further comprising a protecting layer disposed on a surface of the claw portion.

7. The clamping mechanism as claimed in claim 6, wherein the protecting layer is made of soft plastic or rubber.

8. The clamping mechanism as claimed in claim 4, wherein the claw portion is made of hard plastic.

9. The clamping mechanism as claimed in claim 2, wherein the clamping mechanism comprises two connecting members, one of the connecting members connects the first end and the first clamping member in such a manner that the one of connecting members is movable with respect to the main body, and the other of the connecting members connects the second end and the second clamping member in such a manner that the other of the connecting members is movable with respect to the main body.

10. The clamping mechanism as claimed in claim 1 further comprising a thin surface or a net structure, wherein the first clamping member comprises two claw portions, and the thin surface or the net structure is disposed between the claw portions.

11. The clamping mechanism as claimed in claim 1 further comprising a thin surface or a net structure, wherein the second clamping member comprises two claw portions, and the thin surface or the net structure is disposed between the claw portions.

12. The clamping mechanism as claimed in claim 1, wherein the second clamping member is rotatable with respect to the connecting member.

13. An image capture system, comprising:
a camera module; and
a clamping mechanism joined to the camera module, wherein the clamping mechanism comprises a main body, a first clamping member rotatably disposed on the main body, a second clamping member corresponding to the first clamping member and at least one connecting member movably connecting the main body and the second clamping member.

14. The image capture system as claimed in claim 13, wherein the image capture module comprises a receiving space in which the clamping mechanism is secured.

15. The image capture system as claimed in claim 13, wherein the camera module comprises a lens and an image sensor.

16. The image capture system as claimed in claim 13, wherein the clamping mechanism further comprises a securing member which is detachable and secures the main body to the camera module.

17. A clamping mechanism, comprising:
a main body;
a first clamping member rotatably connected to the main body;
a second clamping member disposed away from the first clamping member; and
at least one connecting member movable with respect to the main body, wherein the second clamping member is connected to the connecting member.

18. The clamping mechanism as claimed in claim 17, wherein the second clamping member is rotatable with respect to the connecting member.

19. An image capture system, comprising:
a camera module; and
a clamping mechanism as claimed in claim 17, holding the camera module by the first clamping member and the second clamping member.

20. The image capture system as claimed in claim 19, wherein the image capture module comprises a receiving space in which the clamping mechanism is secured.
